(19) United States
(12) Patent Application Publication
(10) Pub. No.: US 2012/0000654 A1
(43) Pub. Date: Jan. 5, 2012

(54) METHOD FOR STABILIZATION OF MINE VOIDS USING WASTE MATERIAL AND A BINDING AGENT

(76) Inventor: Charles Russell Justice, Betsy Layne, KY (US)

(21) Appl. No.: 13/006,421

(22) Filed: Jan. 13, 2011

Related U.S. Application Data
(63) Continuation-in-part of application No. 12/827,771, filed on Jun. 30, 2010, now abandoned.

(51) Int. Cl. E21B 33/05; C04B 18/06

(52) U.S. Cl. 166/285; 106/706

(57) ABSTRACT

A highwall mining borehole backfill composition utilizing waste glass and fly ash can be used as a backfill utilizing waste products that would normally have to be landfilled. The composition is a cost effective mixture of cement, fly ash, glass and water and may incorporate additional fine and coarse aggregates as well as chemical admixtures. Fly ash takes the place of some or all of the fine aggregate, and cullet takes the place of coarse aggregate in a mixture of concrete. Use of the backfill supports the overlying strata so as to eliminate or reduce the need for barrier pillars.

### CROSS REFERENCE TO RELATED APPLICATIONS

This application claims the benefit of U.S. Provisional Patent Application Ser. No. 61/222,687, entitled “System and Method for Stabilization of Mine Voids Using Waste Material and a Binding Agent” filed Jul. 2, 2009, and a Continuation-In-Part of U.S. Utility patent application Ser. No. 12/827,771 filed Jun. 30, 2010.

### BACKGROUND

1. Technical Field

This composition and method relates to mining technology. More specifically, this application relates to a composition for backfilling highwall mining boreholes with a composition that adds stability to the overlying strata and increases recovery from a coal seam while permitting an environmentally friendly alternative for the disposal of waste glass and fly ash.

2. Problems in the Art

Much of the readily accessible high quality coal available by deep mining in the United States was extracted decades ago. Innovations in mining technology have facilitated the extraction of additional coal from mountains by way of contour mining, thus permitting coal seam heights from about 2 feet to over 15 feet to be economically mined.

Contour mining requires the removal of overburden along the contour of the hillside, thus revealing the seam. Coal is extracted from the removed overburden using surface mining separation techniques. The overburden removal creates a working surface for highwall miner which bores into the hillside at prescribed intervals known to create an acceptably minimal risk of subsidence of the overlying strata.

Stability is a major ground control related safety concern in contour mining, and operators are required to develop and follow an appropriate mining ground control plan. The plans usually specify the following parameters: hole width, maximum hole depth, maximum overburden depth, seam thickness, web pillar width, barrier pillar width and number of holes between barriers. Barrier pillars are utilized to prevent subsidence of the overlying strata and essentially require skipping the creation of a hole along the prescribed interval so as to leave a pillar of coal. Mine subsidence creates depressions, sags, and cracks in the surface due to collapsing strata above voids created by the extraction of coal. This subsidence of the strata destabilizes the mountain. For purposes of convenience only, the words hill and mountain are used interchangeably throughout this application and the selection of either is not intended to be exclusive of other similar terms.

Subsidence can also trap cutter heads and push beams within the mountain, thus increasing cost and decreasing efficiency and the quantity of recoverable coal. Subsidence requires expensive environmental remediation techniques to stabilize the mountain and to fill in cracks that develop along the surface.

Continuous highwall mining utilizes a continuous mining system. A cutter head pushes substantially horizontally into the coal seam. The loader operator loads a push beam from a storage location onto a push beam transfer mechanism. The push beams are typically fully-enclosed except for the proximal and distal ends and typically consist of a pair of augers that run the length of the push beam. The push beams are joined at the push beam transfer mechanism and act to jointly drive the cutter head as well as convey the mined coal out of the borehole. Being hinged at each end allows the string of push beams and cutterheads to be navigated through rolls and undulations within the coal seam.

Waste glass comprises approximately 5.7% of the solid waste generated in the United States. Recycling glass is not economically feasible as it costs more to recycle than to produce a given quantity of glass. Waste glass currently is placed in landfills where it occupies valuable landfill volume that could be put to better use. Being primarily composed of silica, glass has a neutral environmental effect when landfilled except for accelerating the need for additional landfills. Waste glass is routinely broken down to small, gravel-sized, pieces with dull edges called cullet. It would be environmentally advantageous to avoid placing waste glass into landfills. It would be economically advantageous to dispose of waste glass without recycling it.

Fly ash is also a waste product with significant impact on landfill volume. Fly ash is one of two types of coal ash, the other being bottom ash, that are a residue from coal combustion. Only about 39% fly ash is recycled, the remainder is landfilled. The components of fly ash vary considerably due to variation in coal chemistry, but all fly ash includes substantial amounts of silicon dioxide (SiO₂) (both amorphous and crystalline) and calcium oxide (CaO), both being common to coal bearing rock strata. For power companies, landfilling is a costly disposal option, because the fly ash placed there must be treated as a potentially toxic industrial waste as it may become contaminated with significant amounts of environmental toxins such as arsenic, beryllium, cadmium, hexavalent chromium, lead, vanadium, and zinc. In the past, fly ash was indiscriminately released into the atmosphere.

When designing a highwall mining layout, the mining engineer must specify 1) web pillar width, 2) number of web pillars between barrier pillars and 3) barrier pillar width. The design parameters are determined by the highwall miner hole width, the mining height and the overburden depth. In addition, the mine planner must estimate the pillar strength, the applied stress on pillars and the pillar stability factor.

Mining safety regulations requires that the miner leave barrier pillars or web pillars at prescribed intervals to support the overlying strata and to prevent subsidence. Subsidence is considered environmentally detrimental and creates a risk that a highwall collapse, should one occur, will migrate into an active working area and pose a significant safety risk to miners. A typical barrier pillar is 6 to 12 feet across and a typical web pillar is 5 to 8 feet across. Barrier pillar spacing is typically such that after 10 holes are drilled, the 11^{th} hole position is skipped to create the barrier pillar. The less stable the overlying strata, the more often barrier pillars must be utilized. Research has shown that the three major factors that affect the design of highwall mining pillars are (1) the average in situ mass coal strength, (2) the pillar width to height ratio, and (3) the strength of the interfaces between the coal seam and the roof and floor when the whole thickness of the seam is mined. Ideally, a backfill composition will provide at least as much stability to the overlying strata as the pillar it is intended to replace.

The stability factor for a web pillar is given by:

$${SF}_{WP} = \frac{{S}_{I} [ 0.64 + 0.54 {W}_{WP} / H ]}{[ {S}_{V} ( {W}_{WP} + {W}_{E} ) / {W}_{WP} ]}$$

Where: S_{I} is in situ coal strength, S_{V} is in situ vertical stress, W_{WP} is web pillar width, W_{E} is highwall miner cut width, and H is mining height. In situ vertical stress depends on the overlying rock density and overburden depth.

The stability factor for a barrier pillar is determined as:

$${SF}_{BP} = \frac{{S}_{I} [ 0.64 + 0.54 {W}_{BP} / H ]}{[ {S}_{V} ( {W}_{PNP} + {W}_{BP} ) / {W}_{BP} ]}$$

Where: S_{I} is in situ coal strength, S_{V} is in situ vertical stress, W_{PN} is panel width, W_{BP} is barrier pillar width, and H is mining height. Barrier pillars with a width to height ratio greater than 3 are superior for sound geomechanics reasons.

Computer programs well known in the art such as SDPS and CISPM can be used for evaluation of stress at mine areas with varying overburden conditions, pillar and barrier arrangements, and subsidence parameters (settlement, horizontal displacement, curvature and tilt). Based on empirical or site-specific regional parameters, SDPS calculates the ground deformation indices using both the profile function method and the influence function method. The profile function method requires the following minimum input: panel width, overburden depth, seam thickness, and percent of hard rock within the overburden. The influence function method requires that the mine plan and measured subsidence survey information applicable to the area be input, although average parameters applicable for eastern U.S. coal fields can be selected. The results can be plotted in relation to mine or surface structure geometry.

### SUMMARY OF THE DISCLOSED EMBODIMENTS

A highwall mining borehole backfill composition utilizing waste glass and fly ash is used as a backfill utilizing waste products that would normally have to be landfilled. The composition is a cost effective mixture of cement, fly ash, glass and water and may incorporate additional fine and coarse aggregates as well as chemical admixtures. Fly ash takes the place of some or all of the fine aggregate, and cullet takes the place of coarse aggregate in a mixture of concrete. Use of the backfill supports the overlying strata so as to eliminate or reduce the need for barrier pillars. The resulting concrete mix is then placed in highwall boreholes through selected delivery means, e.g. pneumatically, mechanically, or hydraulically delivered. Colorants can also be added to minimize the contrast with surrounding strata.

Highwall mining is a combination of surface and underground mining techniques. Overburden is removed to gain access to the coal until they reach a point where the overburden removal costs exceed the value of the coal being surface mined, which is referred to as reaching the final highwall. A highwall mining system is set up along the face of the final highwall. A continuous miner begins mining its way under the mountain to the maximum distance allowed by equipment design and geological conditions. Incremental increases in borehole depth are possible as push beams, also known as gathering arms, are attached to the existing chain of push beams driving the cutter head. The coal is typically conveyed from the cutter head of the miner on a conveyer system that is incrementally increased in length as the cutter head advances into the mountain. After a borehole is mined out, the push beams that were added to increase the length are removed one by one until the cutter head is retracted from the hole. The equipment then moves down the highwall and mines another borehole that is typically substantially parallel to the previous one mined. Spacing of the boreholes is critical to the avoidance of subsidence and is related to the depth of the coal seam, the density of the overlying strata, and the strength of the coal. Backfilled boreholes provide crucial support and can eliminate or reduce the need for barrier pillars to support the overlying strata. Backfilled boreholes that leave little or no headspace are especially effective in preventing subsidence.

At a constant water-cement ratio (i.e. the ratio of the mass of water, exclusive only of that absorbed by the aggregates, to the mass of Portland cement in concrete, mortar, or grout), as the amount of entrained air (by volume of the total mixture) increases, the voids-cement ratio (i.e. volumetric ratio of air plus net mixing water to cement in a concrete mixture) decreases. This generally results in a reduction of concrete strength. However, air-entrained concrete can have a lower water-cement ratio than non-air-entrained concrete and still provide adequate workability. Thus, the strength reduction associated with a higher air content can be offset by using a lower water-cement ratio. For moderate-strength concrete such as that used in rigid pavements, each percentile of entrained air can reduce the compressive strength by about 2 to 6 percent.

The backfill compositions disclosed herein provide support equal to or better than the compressive strength of coal, i.e. approximately 900 psi (6,205 KPa), and is cheaper than using concrete due to the use of reclaimed waste materials. Various mixture strengths can be obtained through modification of the mixture composition by a process known commonly as concrete mix design. Compressive strength is typically modified by adjusting the water-to-cement ratio.

The use of products that would normally be landfilled has a significant impact on the final cost of the concrete since waste producers pay to have the waste removed and economic incentives exist for those generating waste to “recycle” by diverting the waste from landfills for use as aggregate by the generation of LEED® Green Building Rating System points as a credit to the waste producer.

### DETAILED DESCRIPTION OF THE PREFERRED EMBODIMENTS

Contour mining, while useful at extracting a significant amount of coal from narrow seams, significantly weakens the structural integrity of overlying strata. The coal is extracted in sections of the exposed coal seam at intervals which provide adequate support for the ground above the affected coal seam.

Backfilling with a material that has at least the same compressive strength as coal increases the stability of the overlying strata and permits greater coal recovery by changing the relevant geotechnical parameters used to create the ground control plan so as to alter the spacing requirements between holes, or at least avoiding having to skip holes to avoid subsidence. This approach increases the available coal for removal, thus impacting the economics of contour mining in addition to providing environmental benefits from control of subsidence and disposal of waste glass and fly ash.

As waste glass is considered to have no real value and is typically landfilled, the acceptance of waste glass results in an economic benefit to the acceptor. Coal rail cars sent to industrial centers typically return empty, thus transportation to mining regions is cost effective and readily available as it benefits the carrier as well as the acceptor. Fly ash is likewise deemed a liability and can be transported back to coal producing regions by the same rail cars that transport the coal where the acceptor pays little for the transportation and is also paid to accept the waste material. The use of waste material for which the acceptor is paid to accept as a significant component of concrete and the resulting increased efficiencies of increasing the recover of coal from a seam create an attractive economic model, and produces a positive environmental impact as it diverts waste material from landfills to mines while reducing the risk of subsidence strata overlying coal seams.

A mixture of cement, glass, and fly ash can be created which, when mixed with water, adds stability to mine voids and provides an alternative disposal method for fly ash and waste glass. Aggregate typically comprises between 60 to 75% of the total volume of cement. Fine aggregates generally consist of natural sand or crushed stone with most particles passing through a ⅜-inch (9.5 mm) sieve. Coarse aggregates are any particles greater than 0.19 inches (4.75 mm), but generally range between ⅜ inches and 1.5 inches (9.5 mm to 37.5 mm) in diameter. Gravels constitute the majority of coarse aggregate used in a typical cement mix with crushed stone making up most of the remainder. Fly ash can be used as a substitute for some or all of the fine aggregate in a concrete mix. Waste glass, typically in the form of cullet, can be used as a substitute for some or all of the coarse aggregate in a concrete mix. The use of fly ash and glass in a cement mix has no adverse chemical environmental impact when used as a complete or partial backfill in mined out holes and the mix itself, when appropriately formulated, has a more than sufficient compressive strength to support the overlying strata.

Selection of coarse aggregate size and content is empirically based on mixture workability. Maximum aggregate size will affect such parameters as workability, strength, and quantity of cement paste. Large aggregate may be difficult to consolidate and compact which creates a honeycombed structure or large air pockets. Cullet, typically available from waste management sites, is ideal for use as a large aggregate due to its small size and rounded edges. The physical characteristics of aggregates are shape, texture, and size. These can indirectly affect strength because they affect the workability of the concrete. If the aggregate makes the concrete unworkable, the contractor is likely to add more water which will weaken the concrete by increasing the water to cement mass ratio.

Chemical admixtures may also be utilized with cement formulations which include cullet and fly ash. Chemical admixtures for cement are classed according to function. There are five distinct classes of chemical admixtures: air-entraining, water-reducing, retarding, accelerating, and plasticizers/superplasticizers. All other varieties of admixtures fall into the specialty category whose functions include corrosion inhibition, shrinkage reduction, alkali-silica reactivity reduction, workability enhancement, bonding, damp proofing, and coloring.

The wet concrete mix must be sufficiently workable to allow delivery into the borehole by methods commonly available at mines such as pneumatic or hydraulic delivery. After the concrete is placed into the void, a satisfactory moisture content and temperature (between 50° F. [10° C.] and 75° F. [24° C.] must be maintained to cure the concrete. The strata surrounding a coal seam typically provides a consistent cool temperature of approximately 55° F. (13° C.) and provides additional moisture thus provides a suitable environment for the curing of concrete.

Curing has a strong influence on the properties of hardened concrete such as durability, strength, water-tightness, abrasion resistance, volume stability, and resistance to freezing and thawing. Exposed surfaces are especially sensitive to curing. Surface strength development can be reduced significantly when curing is defective.

Water causes the hardening of concrete through a process called hydration. Hydration is a chemical reaction in which the major compounds in cement form chemical bonds with water molecules and become hydrates or hydration products. When concrete dries, it stops curing and reaches its final strength. Concrete with too little water may be dry but is not fully reacted, thus the quicker the cure the weaker the concrete. The reaction of water with the cement in concrete is extremely important to its properties and reactions may continue for many years. The water not consumed in the hydration reaction will remain in the microstructure pore space. These pores make the concrete weaker due to the lack of strength-forming calcium silicate hydrate bonds. Some pores will remain no matter how well the concrete has been compacted. This initial hydrolysis slows down quickly after it starts resulting in a decrease in heat evolved. Due to the slow curing process, it is common to use a 28-day test to determine the relative strength of concrete.

Most freshly mixed concrete contains considerably more water than is required for complete hydration; however, any appreciable loss of water by evaporation or otherwise will delay, or prevent hydration. If temperatures are favorable, hydration is relatively rapid the first few days after concrete is placed; retaining water during this period is important. Good curing means evaporation should be prevented or reduced. The conditions in a mine void are ideal for concrete curing as they typically provide a constant temperature of approximately 55° F. (13° C.) and contain moisture therefore preventing the concrete mixture from drying too rapidly. Horizontal mine voids provide little if any head space upon filling which inhibits or prevents the evaporation of water from the cement.

The water-cement ratio is a convenient measurement whose value is well correlated with cement strength and durability. In general, lower water-cement ratios produce stronger, more durable concrete. If natural pozzolans are used in the mix (such as fly ash) then the ratio becomes a water-cementitious material ratio (cementitious material=portland cement+pozzolonic material). Pozzolans in finely divided form and in the presence of moisture, chemically react with the calcium hydroxide that is released by the hydration of Portland cement to form compounds possessing cementitious properties. The American Concrete Institute (“ACT”) method bases the water-cement ratio selection on desired compressive strength and then calculates the required cement content based on the selected water-cement ratio. Table 1 provides a general estimate of 28-day compressive strength vs. water-cement ratio (or water-cementitious ratio).

Air entrainments add and entrain tiny air bubbles in the concrete, which will reduce damage during freeze-thaw cycles by providing a space for water to expand, thereby increasing the concrete's durability. However, as shown in Table 1, entrained air is a trade-off with strength, as each 1% of air may result in 5% decrease in compressive strength.

TABLE 1
Relative strengths of air-entrained
and non-air-entrained concrete

| | |
|---|---|
| 28 Day Compressive | Water-cement ratio by mass |

| Strength in MPa (psi) | non-air entrained | air-entrained |
|---|---|---|
| 41.4 (6000 psi) | 0.41 | — |
| 34.5 (5000 psi) | 0.48 | 0.4 |
| 27.6 (4000 psi) | 0.57 | 0.48 |
| 20.7 (3000 psi) | 0.68 | 0.59 |
| 13.8 (2000 psi) | 0.82 | 0.74 |

Typical concrete mix designs typically incorporate between 60 to 75 volume % of the total aggregate volume in the concrete mix, between 15 and 20 volume % water, and about 10 to 15 volume % cement. The ratio of fine to coarse aggregate is variable, but typically fine aggregate comprises between 35 to 55% of the total aggregate volume. A prophetic concrete mix design and prophetic ranges are described in Example 1. Fly ash and cullet are substituted for up to 100% of the fine aggregate and coarse aggregate respectively, depending on the desired properties and economics of the backfill. In Example 2, the use of cullet and fly ash in a concrete mix (mix formulation 3 in Table 3) can provide sufficient support to justify the elimination of a pillar as shown in Table 4. In one embodiment the concrete mix will contain between 40 to 60 mass % of glass aggregate. In an additional embodiment the concrete mix will contain between 40 to 50 mass % of glass aggregate.

### Example 1

TABLE 2
Mix formulation with workable ranges for components

| Component | Vol. % | Minimum Vol. % | Maximum Vol. % |
|---|---|---|---|
| Portland cement | 11 | 5 | 15 |
| Coarse aggregate | 41 | 40 | 60 |
| Fine aggregate | 26 | 0 | 35 |
| Water | 16 | 10 | 33 |
| Air | 6 | 0 | 8 |

### Example 2

TABLE 3
Concrete Mix Design Trials (mass %)

| | Mix | Mix | | Mix |
|---|---|---|---|---|
| | For- | For- | Mix | Formulation |
| Component | mulation 1 | mulation 2 | Formulation 3 | 4 |
| <⅜″Cullett | 80 | 0 | 44.6 | 0 |
| No. 8 Gravel | 0 | 39.9 | 0 | 79.8 |
| Silica sand | 0 | 39.9 | 30.6 | 0 |
| Portland cement | 11.5 | 11.5 | 11.8 | 11.6 |
| Water | 8.5 | 8.7 | 13.0 | 8.6 |

TABLE 4
Test Results* for Concrete Mix Design Trials in Table 3

| | Days Cured | Force Applied (lbs) | Crush Strength (psi) |
|---|---|---|---|
| Formula 1 | 13 | 10,500 | 371.4 |
| | | (4,763 kg) | (2.6 MPa) |
| | 28 | 4,750 | 168.0 |
| | | (2,155 kg) | (1.2 MPa) |
| Formula 2 | 13 | 66,250 | 2345.5 |
| | | (30,051 kg) | (16.2 MPa) |
| | 28 | 65,250 | 2307.7 |
| | | (29,597 kg) | (15.9 MPa) |
| Formula 3 | 13 | 18,000 | 636.7 |
| | | (8,165 kg) | (4.4 MPa) |
| | 28 | 31,000 | 1096.6 |
| | | (14,062 kg) | (7.6 MPa) |
| Formula 4 | 14 | 18,250 | 645.6 |
| | | (8,278 kg) | (4.4 MPa) |
| | 14 | 16,750 | 592.5 |
| | | (7,598 kg) | (4.1 MPa) |

*Field results at ±8% of reported result.

The foregoing detailed description is given primarily for clearness of understanding and no unnecessary limitations are to be understood therefrom for modifications can be made by those skilled in the art upon reading this disclosure and may be made without departing from the spirit of the invention and scope of the appended claims.

What is claimed is:

1. A method of backfilling a highwall mining borehole comprising the steps of:
a. delivering a concrete mix into said borehole, said mix including at least cement, a fine aggregate at least partially composed of fly ash, a coarse aggregate at least partially composed of glass aggregate, and water; and
b. allowing said concrete mix to cure within said borehole to a strength of at least 900 lbs/in².

2. The method of claim 1, wherein said glass and said fly ash are waste products whose final inclusion in said concrete mix reduces the cost of said concrete mix to less than the cost of a gravel and sand containing concrete mix.

3. The method of claim 1, wherein said glass aggregate has an approximate average diameter of less than ⅜ inches.

4. The method of claim 1, wherein said concrete mix is comprised of between approximately 40 to 60 mass % glass aggregate.

5. The method of claim 1, wherein said concrete mix is comprised of between 40 to 50 mass % glass aggregate.

6. The method of claim 1, wherein said concrete mix further comprises at least one additional type of fine aggregate.

7. The method of claim 6, wherein said additional type of fine aggregate selected from the group consisting of sand and crushed stone.

8. The method of claim 1, wherein said concrete mix further comprises at least one additional type of coarse aggregate.

9. The method of claim 1, wherein said glass is in the form of cullet.

10. The method of claim 9, wherein said concrete mix further comprises at least one chemical admixture.

11. The method of claim 1, wherein said concrete mix further comprises air entrainments.

12. The method of claim 1, wherein said concrete mix comprises up to 60% cullet.

13. The method of claim 1, wherein said concrete mix comprises up to 25% fly ash.

14. A method of recycling waste glass and fly ash by their inclusion in a concrete mix utilized as a borehole backfill comprising the steps of:
a. supplementing waste fly ash into said concrete mix as a fine aggregate;
b. supplementing waste glass into said concrete mix as a coarse aggregate; and
c. optimizing the concrete mix to produce concrete with a 28 day cure of at least substantially the same compression strength as the coal which said concrete mix replaces in said mine void.

15. The method of claim 14, wherein said concrete is cured to a compressive strength of at least 900 lbs/in².

16. The method of claim 15, wherein said concrete mix includes up to 60% waste glass.

17. The method of claim 16, wherein said concrete mix includes up to 25% fly ash.

18. A method of mining comprising the steps of:
a. highwall mining a seam of coal;
b. backfilling a borehole left by highwall mining prior to a barrier pillar position for the purpose of supporting overlying strata, said backfill being a wet concrete mixture containing glass and fly ash; and
c. continuing to highwall mine said seam of coal at said barrier pillar position for the purpose of increasing the quantity of recovered coal from said coal seam.

19. The method of claim 18, wherein said glass is waste glass and said fly ash is waste fly ash selected so as to reduce the cost of backfilling said borehole with concrete.

20. The method of claim 19, wherein said waste glass is cullet.

21. The method of claim 20, wherein said wet concrete mixture is formulated to cure within a borehole to a compressive strength of at least 900 lbs/in².

22. The method of claim 21, wherein said wet concrete mixture is formulated to cure within a borehole to a compressive strength at least as great as said seam of coal.
